(19) United States
(12) Patent Application Publication
(10) Pub. No.: US 2005/0079855 A1
(43) Pub. Date: Apr. 14, 2005

(54) Architecture that enables a mobile virtual network operator (MVNO) to create a branded wireless offering

(76) Inventors: Rashesh J. Jethi, Fremont, CA (US); Paul W. Nelson, San Francisco, CA (US); Venkatesan Raghavan, San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/919,820

(22) Filed: Aug. 16, 2004

Related U.S. Application Data
(60) Provisional application No. 60/496,973, filed on Aug. 20, 2003.

(51) Int. Cl. H04M 11/00

(52) U.S. Cl. 455/403; 455/414.1

(57) ABSTRACT

An architecture is presented that enables a Mobile Virtual Network Operator (MVNO) to create a branded wireless offering. An MVNO-enabler (MVNE) system acts as an intermediary between a brand system and a wireless network. The MVNE system controls customer management, order management, applications management, and billing management. In one embodiment, the MVNE system comprises modules for customer management, order management, applications management, and billing management. In another embodiment, the MVNE system comprises interfaces to third party systems that provide these services. In yet another embodiment, the MVNE system can comprise interfaces to a plurality of brand systems, a plurality of wireless networks, and a plurality of third party systems. By using various interfaces, a customized wireless offering can be created.

### CROSS-REFERENCE TO RELATED APPLICATIONS

This application claims priority from the following U.S. provisional patent application, which is hereby incorporated by reference: Ser. No. 60/496,973, filed on Aug. 20, 2003, entitled “Enabling Private Label Wireless Solutions by Interfacing with Mobile Virtual Network Operators and Wireless Carriers and Providing Additional Services.” This application is also related to the following U.S. utility patent application, which is hereby incorporated by reference: Ser. No. ______, filed on Aug. ______, 2004, entitled “______.”

### BACKGROUND OF THE INVENTION

1. Field of the Invention

The present invention is related to an architecture that enables a Mobile Virtual Network Operator (MVNO) to create a branded wireless offering and, more particularly, to a system for enabling an MVNO to create a customized wireless offering.

2. Description of the Background Art

Many companies would like to enter the wireless services market, but there is a high barrier to entry. Technology is needed for customer management, order management, applications management, and billing management. Third-party interfaces are needed in order to outsource certain services, such as customer care and distribution and fulfillment. Subscriber interfaces are needed, such as call centers and web portals.

Even more significant is the fact that wireless carriers must provide a nationwide cellular network, voice and data transport, management of the North American numbering plan, and standard (raw) Call Detail Record (CDR) feeds to input into a billing system. Not only are cellular expertise and infrastructure expensive, but the number of subscribers required in order to operate profitably is several million.

In response, new players have emerged in the wireless market. They are known as Mobile Virtual Network Operators (MVNOs). MVNOs offer branded wireless services, including the customer management, order management, applications management, and billing management technology mentioned above. However, MVNOs do not have wireless networks. Instead, MVNOs rely on network operators to provide the underlying equipment and communication capabilities, interfacing their systems with network operator systems as necessary. In general, each MVNO offers wireless services under a different brand.

While MVNOs do not operate wireless networks, implementing the rest of a branded wireless offering still requires a great deal of time and other resources. MVNOs need to provide subscriber interfaces, third-party interfaces, and technology for customer management, order management, applications management, and billing management. In addition, these services must be interconnected to provide a complete solution. These costs and complexities prevent many consumer brands from entering the wireless services market and becoming MVNOs.

What is needed is a way to handle the above costs and complexities, thereby enabling consumer brands to be MVNOs.

### SUMMARY OF THE INVENTION

The present invention overcomes the limitations of the prior art by providing an architecture that enables a Mobile Virtual Network Operator (MVNO) to create a branded wireless offering. An MVNO-enabler (MVNE) system acts as an intermediary between a brand system and a wireless network and comprises a brand system interface and a wireless network interface. Together, the MVNE system, brand system, and wireless network provide a branded wireless offering.

The MVNE system controls customer management, order management, applications management, and billing management. In one embodiment, the MVNE system comprises modules for customer management, order management, applications management, and billing management. In another embodiment, the MVNE system comprises interfaces to third party systems that provide these services.

In one embodiment, the MVNE system enables an MVNO to create a customized wireless offering. In this embodiment, the MVNE system can comprise interfaces to a plurality of brand systems, a plurality of wireless networks, and a plurality of third party systems. By using various interfaces, a customized wireless offering can be created.

### BRIEF DESCRIPTION OF THE DRAWINGS

FIG. 1 illustrates a block diagram of a prior art system that provides a branded wireless offering.

FIG. 2A illustrates a block diagram of a system that provides a branded wireless offering, according to one embodiment of the invention.

FIG. 2B illustrates a block diagram of a system that provides a branded wireless offering, according to another embodiment of the invention.

FIG. 3 illustrates a block diagram of a system that provides a customizable branded wireless offering, according to one embodiment of the invention.

The Figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE EMBODIMENTS

Being an MVNO can help a consumer brand leverage a strong brand, customer base, distribution, marketing, and sometimes also proprietary content to create a unique wireless service offering. Creating a branded wireless offering financially benefits consumer brands by deriving additional value from existing customers, distribution channels, and brand equity. Successful branded offerings will yield consumer brands with a new stream of large, recurring subscriber revenue, a new branded channel for communicating with customers, and a unique means to enhance loyalty programs and deepen customer relationships.

The existence of MVNOs is also financially beneficial to network operators. MVNOs can dramatically improve subscriber profitability, fill excess network capacity, and provide a highly efficient means to access untapped consumer markets. Through MVNOs, network operators can create a highly profitable wholesale business, improve their return on invested capital, and leverage established brands to reduce customer acquisition expenses.

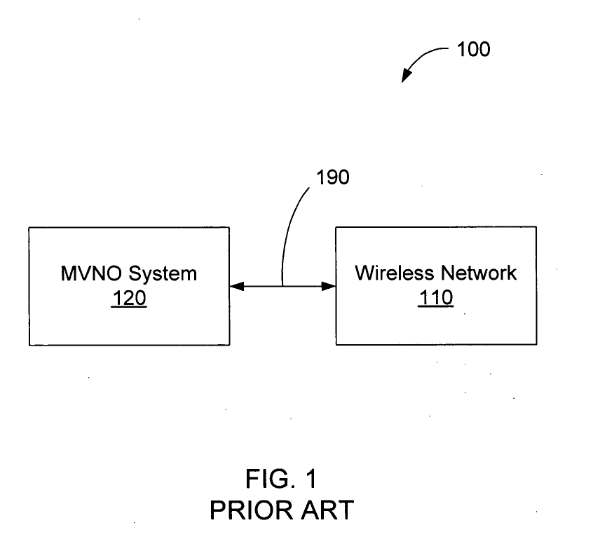

FIG. 1 illustrates a block diagram of a prior art system that provides a branded wireless offering. The illustrated embodiment of system 100 includes one MVNO system 120, one wireless network 110, and a network 190. MVNO system 120 is coupled to wireless network 110 via network 190.

In the illustrated embodiment, wireless network 110 comprises a wireless network, including underlying equipment and communication capabilities. For example, wireless network 110 comprises or interacts with wireless base stations, mobile switching centers, messaging service centers (such as short MSCs and multimedia MSCs), home location registers (HLR), and a wired line carrier. Wireless network 110 enables services such as, for example, provisioning, call detail record (CDR) retrieval, trouble ticketing, coverage, suspension, wireless number portability (WNP), and operational support systems/business support systems (OSS/BSS) integration. When an MVNO customer uses a wireless device to make a phone call, the call travels through wireless network 110.

In the illustrated embodiment, MVNO system 120 is a computer system that implements the rest of the branded wireless offering (e.g., everything except the wireless network 110). In one embodiment, MVNO system 120 provides subscriber interfaces and technology for customer management, order management, applications management, and billing management, interconnecting these services to provide a complete solution. In another embodiment, MVNO system 120 also provides marketing, customer acquisition, and branding of the wireless offering.

MVNO system 120 can comprise, for example, a single computer or a plurality of interconnected computers. These computers can be general-purpose computers or computers that have been configured to perform the functions described above. MVNO system 120 can also comprise one or more databases to store, for example, customer information, order information, and billing information.

In one embodiment, network 190 is a public network, such as the Internet. In another embodiment, network 190 is a private IP-based Local Area Network (LAN) or Wide Area Network (WAN). The communication links to and from network 190 can be wireline or wireless (i.e., terrestrial- or satellite-based transceivers).

1. System for Providing a Branded Wireless Offering

As discussed above, while MVNOs do not operate wireless networks, they still face the costs and complexities of implementing the rest of a branded wireless offering. If MVNOs could outsource some of these costs and complexities, consumer brands would be more likely to enter the wireless services market.

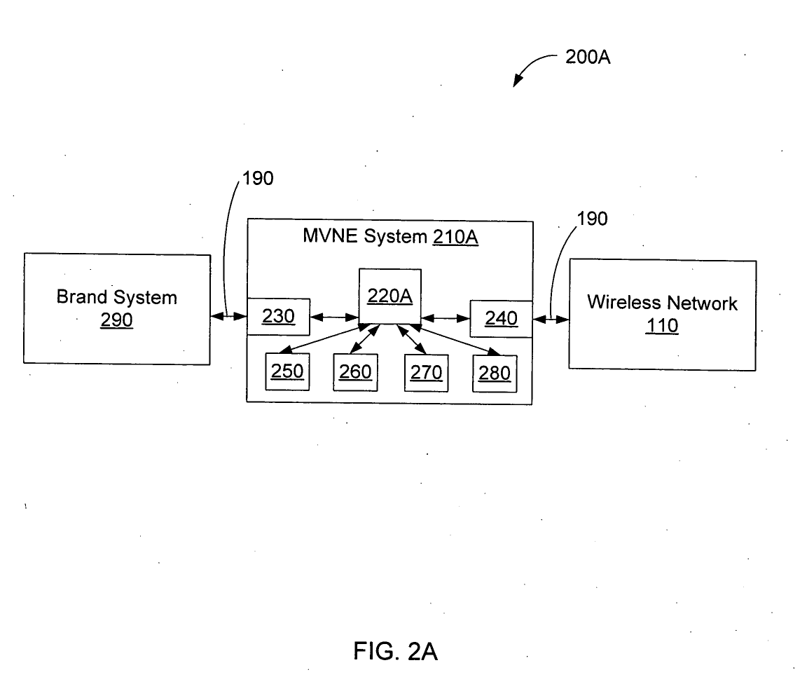

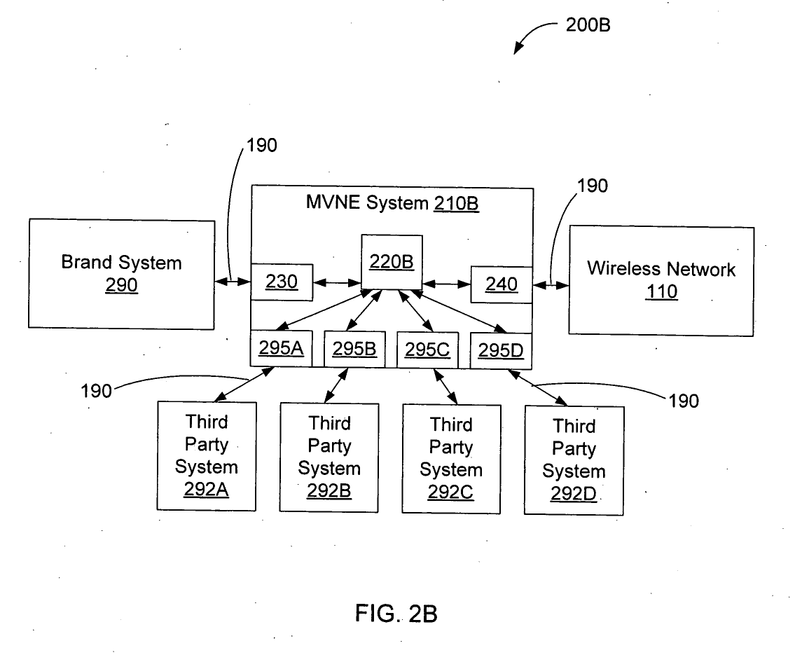

FIG. 2A illustrates a block diagram of a system that provides a branded wireless offering, according to one embodiment of the invention. The illustrated embodiment of system 200A includes one MVNO-enabler (MVNE) system 210A, one brand system 290, one wireless network 110, and a network 190. MVNE system 210A interacts with brand system 290 and wireless network 110, acting as an intermediary between them. MVNE system 210A has two interfaces, 230 and 240, which enable it to interact (via network 190) with brand system 290 and wireless network 110, respectively.

In the illustrated embodiment, brand system 290 is a computer system that provides marketing, customer acquisition, and branding of the wireless offering. Brand system 290 is similar to MVNO 120, except that brand system 290 does not provide technology for customer management, order management, applications management, and billing management. Instead, these services are provided by MVNE system 210A.

In the illustrated embodiment, MVNE system 210A includes customer management module 250, order management module 260, applications management module 270, and billing management module 280. In the illustrated embodiment, MVNE system 210A also includes a control module 220A, which controls MVNE system 210A and interconnects interfaces 230 and 240 and customer management module 250, order management module 260, applications management module 270, and billing management module 280.

In one embodiment, customer management module 250 controls customer relationship management, including work orders, service orders, trouble tickets, premises management, billing management, loyalty and retention, fraud management, credit management, and contract management. In another embodiment, order management module 260 controls sales, activations, product catalogs, and product campaigns. In yet another embodiment, applications management module 270 controls a messaging framework and an application framework. In yet another embodiment, billing management module 280 controls billing, rating, prepayment, taxation, and revenue assurance.

In the illustrated embodiment, wireless network 110 and network 190 perform similar functions as described above with respect to the embodiment illustrated in FIG. 1.

FIG. 2B illustrates a block diagram of a system that provides a branded wireless offering, according to another embodiment of the invention. The illustrated embodiment of system 200B includes one MVNO-enabler (MVNE) system 210B, one brand system 290, one wireless network 110, four third party systems 292A, 292B, 292C, 292D, and a network 190. MVNE system 210B interacts with brand system 290, wireless network 110, and third party systems 292, acting as an intermediary between them.

Similar to the embodiment illustrated in FIG. 2A, MVNE system 210B has two interfaces 230 and 240, which enable it to interact with brand system 290 and wireless network 110. In contrast to the embodiment illustrated in FIG. 2A, in this embodiment, MVNE system 210B does not comprise customer management module 250, order management module 260, applications management module 270, and billing management module 280.

Instead, these services are provided by third party systems 292. In the illustrated embodiment, third party system 292A provides customer management services, third party system 292B provides order management services, third party system 292C provides applications management services, and third party system 292D provides billing management services. In one embodiment, third party system 292A comprises Siebel Communications™ software from Siebel Systems, Inc. In another embodiment, third party system 292D comprises Infinys™ Geneva™ Rating and Billing software from Convergys Corporation.

In the illustrated embodiment, MVNE system 210B comprises customer management interface 295A, order management interface 295B, applications management interface 295C, and billing management interface 295D. In the illustrated embodiment, MVNE system 210B uses interfaces 295A, 295B, 295C, 295D to communicate, via network 190, with third party systems 292A, 292B, 292C, 292D, respectively. In the illustrated embodiment, MVNE system 210B also includes a control module 220B, which controls MVNE system 210B and interconnects interfaces 230, 240, 295A, 295B, 295C, 295D. Control module 220B is similar to control module 220A in that it controls MVNE system 210B and interconnects interfaces 230, 240. However, control module 220B differs from control module 220A in that it interconnects interfaces 295A, 295B, 295C, 295D instead of modules 250, 260, 270, 280.

In the illustrated embodiment, brand system 290, wireless network 110, and network 190 perform similar functions as described with respect to the embodiment illustrated in FIG. 2A.

2. System for Providing a Customizable Branded Wireless Offering

It is beneficial for an MVNE to work with several MVNOs so that the MVNE and MVNOs can take advantage of economies of scale. For example, the MVNE can offer to buy large amounts of airtime from an operator of a wireless network 110 in exchange for obtaining a discounted price. As another example, the MVNE can service multiple MVNOs using the same software. When savings from these economies of scale are passed on to MVNOs, they can drastically lower the number of subscribers needed by an MVNO to operate profitably, thereby encouraging consumer brands to enter the wireless services market.

The present invention enables an MVNE to offer an MVNO a choice of services, such as different wireless carriers, different billing providers, and different content providers. In other words, with the present invention, an MVNE can offer customized product and service offerings. For an inflexible MVNE, creating and operating a custom infrastructure to interact with each brand system 290 does not make financial sense. Therefore, the system of the present invention is particularly advantageous because it enables an MVNE to create customized wireless offerings for brand systems 290. Such a system also enables an MVNE to change aspects of a particular branded wireless offering over time if desired.

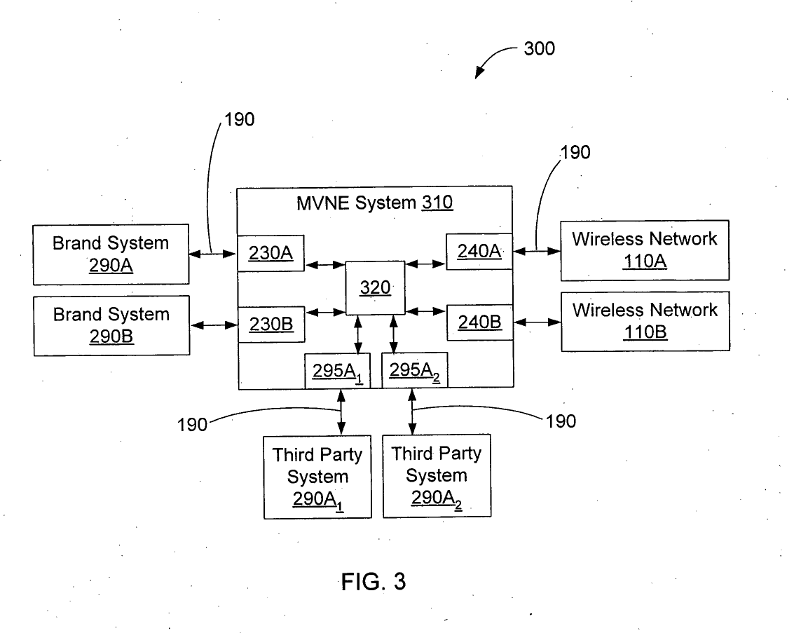

FIG. 3 illustrates a block diagram of a system that provides a customizable branded wireless offering, according to one embodiment of the invention. The illustrated embodiment of system 300 includes one MVNE system 310, a plurality of brand systems 290A, 290B, a plurality of wireless networks 110A, 110B, a plurality of third party systems 292A₁, 292A₂ and a network 190. MVNE system 310 interacts with brand systems 190, wireless networks 110, and third party systems 292A, acting as an intermediary between them.

In the illustrated embodiment, MVNE system 310 includes six interfaces, 230A, 230B, 240A, 240B, 295A₁, and 295A₂. Brand system interfaces 230A, 230B enable MVNE system 310 to interact with two brand systems 290, 290B. Although the illustrated embodiment includes two brand system interfaces 230, MVNE system 310 can have any number of brand system interfaces 230.

Wireless network interfaces 240A, 240B enable MVNE system 310 to interact with two wireless networks 110A, 110B. Third party system interfaces 295A₁, 295A₂ enable MVNE system 310 to interact with two third party systems 292A₁, 292A₂. Although the illustrated embodiment includes two wireless network interfaces 240 and two third party system interfaces 295, MVNE system 310 can have any number of wireless network interfaces 240 and third party system interfaces 295.

In the illustrated embodiment, MVNE system 310 also includes a control module 320, which controls MVNE system 310 and interconnects interfaces 230A, 230B, 240A, 240B, 295A₁, 295A₂. MVNE system 310 also includes (not shown) customer management module 250, order management module 260, applications management module 270, and billing management module 280 (as described above with reference to FIG. 2A) or customer management interface 295A, order management interface 295B, applications management interface 295C, and billing management interface 295D (as described above with reference to FIG. 2B). One embodiment of MVNE system 310 is described in co-pending application Ser. No. ______.

In the illustrated embodiment, brand systems 290, wireless networks 110, and network 190 perform similar functions as described above with respect to the embodiment illustrated in FIG. 2A.

Although system 300 includes two brand systems 290, two wireless networks 110, and two third party systems 292A, system 300 can have any number of brand systems 290, wireless networks 110, and third party systems 292A. For example, a branded wireless offering for MVNO A can include one brand system 290A, one wireless network 110A, and one third party system 292A₁ (e.g., a billing provider). Similarly, a branded wireless offering for MVNO B can include a different brand system 290B, a different wireless network 110B, and a different third party system 292A₂ (e.g., a different billing provider).

If MVNO A wants to offer its customers a choice of wireless networks 110, system 300 can include wireless network 110A and wireless network 110B. If MVNO A wants a third party to handle customer care, system 300 can include an additional third party 292B (e.g., a customer care provider). If MVNO A wants billing to be handled by MVNE system 310 rather than by a third party, system 300 can exclude third party system 292A₁. In this embodiment, MVNE system 310 would also include billing management module 280.

3. Additional Embodiments

Any services, such as front-end, back-end, content/media, retail, payment, and equipment distribution, can be handled by an MVNE system 210 or 310, a brand system 290, or a third party system 292, depending on the MVNO's preferences. Front-end services include, for example, marketing, order entry, activation, customer care, lifecycle management, content provision, and bundled offers. Back-end services include, for example, retailer APIs and portals, billing, rating, mediation, reporting, distribution and fulfillment, reverse logistics, bill presentment, credit checks, finance taxation, and payments. If a third party system 292 is present, it can interface with either the MVNE system 210 or 310 or the brand system 290.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems appears from the description. In addition, the present invention is not described with reference to any particular programming language. It will be appreciated that a variety of programming languages may be used to implement the teachings of the invention as described herein.

One skilled in the art will recognize that the particular examples described herein are merely illustrative of representative embodiments of the invention, and that other arrangements, methods, architectures, and configurations may be implemented without departing from the essential characteristics of the invention. Accordingly, the disclosure of the present invention is intended to be illustrative, but not limiting, of the scope of the invention, which is set forth in the following claims.

1. A system for providing wireless communication services, comprising:
a first interface module for interacting with a brand system;
a second interface module for interacting with a wireless network; and
a control module, coupled to the first interface module and the second interface module, for controlling the system.

2. The system of claim 1, further comprising a third interface module for interacting with a first third party system.

3. The system of claim 2, further comprising a fourth interface module for interacting with a second third party system.

4. The system of claim 1, further comprising a customer management module.

5. The system of claim 1, further comprising an order management module.

6. The system of claim 1, further comprising an applications management module.

7. The system of claim 1, further comprising a billing management module.

8. A system for providing wireless communication services, comprising:
a first interface module for interacting with a first brand system
a second interface module for interacting with a second brand system;
a third interface module for interacting with a wireless network; and
a control module, coupled to the first interface module, the second interface module, and the third interface module, for controlling the system.

9. The system of claim 8, further comprising a fourth interface module for interacting with a third party system.

10. A system for providing wireless communication services, comprising:
a first interface module for interacting with a first wireless network,
a second interface nodule for interacting with a second wireless network;
a third interface module for interacting with a brand system; and
a control module, coupled to the first interface module, the second interface module, and the third interface module, for controlling the system.

11. The system of claim 10, further comprising a fourth interface module for interacting with a third party system.
